(19) United States
(12) Patent Application Publication
(10) Pub. No.: US 2018/0110256 A1
(43) Pub. Date: Apr. 26, 2018

(54) REDUCED-SUGAR COATING COMPOSITIONS AND METHODS FOR COATING THEREWITH

(71) Applicant: Chew LLC, Cambridge, MA (US)

(72) Inventors: Adam John Melonas, Cambridge, MA (US); Ethan Beswick, Cambridge, MA (US); Frederik Jensen, Cambridge, MA (US); Janelle Myers, Cambridge, MA (US)

(73) Assignee: Chew LLC, Cambridge, MA (US)

(21) Appl. No.: 15/332,819

(22) Filed: Oct. 24, 2016

(51) Int. Cl. A23P 20/10; A23L 27/00

(52) U.S. Cl. CPC A23P 20/10; A23L 27/88

(57) ABSTRACT

Reduced-sugar coating compositions comprising gum arabic, maltodextrin, calcium carbonate, salt, one or more sweeteners, an edible oil, and water are provided. Methods for coating a carrier with one or more reduced-sugar coating compositions are further provided.

### TECHNICAL FIELD

This disclosure relates to a formulation and manufacturing method for food products, and more specifically, to a coating designed to be applied to the outside of dry foods in order to simulate a full sugar experience where there is appreciably reduced amounts of sugar by any method of analysis. The reduced-sugar coating may be applied as a syrup or a slurry.

### BACKGROUND

Gum acacia (also known as “gum arabic”) and maltodextrin, as coating agents, have been primarily utilized for their abilities to be applied as transparent coatings in candy and, other snack formulations. The use of similar solutions is well documented by various patent applications, grants, and research. However, these solutions include polyols, have explicitly listed resistant starches as part of their composition, include trioses in place of sugar, and/or primarily contain sugar (i.e., sucrose) as their crystallizing material. See U.S. Pat. No. 8,828,466, incorporated by reference herein in its entirety.

Calcium carbonate, as a coating agent, has primarily been utilized for its ability to build coating layers in chewing gums, candy, and other snack formulations. The use of similar solutions is well documented by various patent applications, grants, and research. However, these solutions include polyols, have explicitly listed resistant starches as part of their composition, include trioses in place of sugar, and/or primarily contain sugar (i.e., sucrose) as their crystallizing material. See U.S. Pat. No. 8,828,466, incorporated by reference herein in its entirety.

Many ready-to-eat (“RTE”) cereals include an outer coating comprised mostly of crystallized sugar. These coatings provide for enhanced “bowl life” of the RTE cereal in milk. “Bowl life” means, unless stated otherwise, the length of time after milk is added to RTE cereal until the RTE cereal becomes soggy in the milk. In addition, the coatings serve to create both a crispy texture that is not brittle and a frosted appearance to the outside of RTE cereals when desirable. Consumers enjoy RTE cereals that have these outer coatings because of the enhanced sweetness and taste that these outer coatings provide, in addition to the frosted appearance that these outer coatings provide. Recently, consumers have been asking for lower-calorie RTE cereals that still have the same sweetness and appearance, but with reduced calorie contents from sugar. Parents also want reduction in the amounts of sugar consumed by children from all sources, including from cereal. In general, serving sizes in dry RTE cereals are standardized to about 1 oz. (28.3 grams), or a range of from about 28 grams to about 30 grams dry weight per serving.

One method of reducing sugar levels in sugar-coated RTE cereals would be by replacing all or a portion of the sugar in such RTE cereals with artificial sweeteners or high-intensity natural sweeteners. However, many of the known artificial sweeteners have off-flavors that a segment of the consuming public can detect and finds offensive. U.S. Patent Application Publication No. 2006/0286223, incorporated by reference herein in its entirety, discloses use of maltodextrin having a dextrose equivalent (“DE”) value of 20 or less to replace sugar in sugar coatings for RTE cereals at levels of from 16% to 28%. Another issue raised by the removal of the sugar from the coating is that the bulk provided by the sugar needs to be replaced, and that the frosted appearance of the outside of the cereal will also be dramatically affected when sugar is removed from the coating. Thus, it is desirable to replace the bulk and maintain the frosted appearance and taste that consumers associate with an existing product when sugar is removed from the coating for that product.

Although there are similarities in approach between the disclosure herein and current industry practices, the combination or utilization of similar high-intensity sweeteners, and the recrystallization of such partially hydrolyzed starches in conjunction with pre-biotic fiber and/or minerals, as described herein, has not previously been disclosed.

The use of gum arabic or similar additives can also be found in literature references, however, their uses in these references are only for flavor modification and sweetness enhancement at lower levels, and contrary to the present disclosure, gum arabic or similar additives as disclosed in such literature references are not intended to perform as integral parts of any coating processes disclosed therein.

It view of the above, it is desirable to provide a sweet coating for a food product, such as a RTE cereal, that has a reduced sugar level while maintaining the bulk, taste, and appearance of a full-sugar coating.

Further, if a way could be found to use natural bulk and/or high-intensity sweeteners in a coating in such a manner that the taste and texture are pleasing to the consumer, it would represent a valuable contribution to the art.

### SUMMARY

In an embodiment, the present disclosure provides a reduced-sugar coating composition comprising gum arabic, maltodextrin, calcium carbonate, salt, one or more sweeteners, an edible oil, and water. In one embodiment, the sweeteners can include, but are not limited to, one or more high-intensity sweeteners such as, for example, Stevia, monkfruit extract, vanilla, and/or thaumatin.

In another embodiment, the present disclosure provides a method for coating a carrier with a reduced-sugar coating composition, comprising the steps of: (a) heating the carrier to maintain a temperature of from about 60° C. to about 85° C.; (b) providing a slurry or syrup of a first reduced-sugar coating composition; (c) applying the slurry or syrup of a first reduced-sugar coating composition to the carrier by spray coating at a rate of from about 0.5 grams to about 6.0 grams slurry or syrup per about 100 grams carrier per minute, at a temperature of from about 80° C. to about 94° C., and at an air flow rate of from about 5 cubic feet per minute (“CFM”) to about 15 CFM, and in such manner that the moisture content of the carrier is kept below 5% by weight; (d) increasing the temperature to from about 95° C. to about 110° C.; (e) holding the applying conditions at from about 95° C. to about 110° C. until the moisture content of the carrier decreases to about 2% by weight; wherein the sugar content of the reduced-sugar coating composition, as applied to the carrier, is in a range of from about 3 grams to about 8 grams per about 29-gram (about 1 ounce) serving, more preferably from about 4 grams to about 7 grams per about 29-gram (about 1 ounce) serving. In one embodiment, the above method for coating a carrier with a reduced-sugar coating composition further comprises providing and applying a powder seed crystal composition after step (c). In another embodiment, the above method for coating a carrier with a reduced-sugar coating composition further comprises providing and applying a powder seed crystal composition comprising maltodextrin, sugar, and an edible oil after step (c). In yet another embodiment, the above method for coating a carrier with a reduced-sugar coating composition further comprises providing, and then applying, a composition comprising one or more flavorants, after step (c). In an embodiment, the carrier can comprise a RTE cereal.

In another embodiment, the present disclosure provides a method for coating a carrier with a reduced-sugar coating composition, comprising the steps of: (a) heating the carrier to maintain a temperature of from about 60° C. to about 85° C.; (b) providing a slurry or syrup of a first reduced-sugar coating composition; (c) applying the slurry or syrup of a first reduced-sugar coating composition to the carrier by spray coating at a rate of from about 2.0 grams to about 60.0 grams slurry or syrup per about 100 grams carrier per minute, at a temperature of from about 80° C. to about 94° C., and at an air flow rate of from about 5 CFM to about 15 CFM, and in such manner that the moisture content of the carrier is kept below 5% by weight; (d) providing a powder seed crystal composition; (e) applying the powder seed crystal composition to the carrier by sifting or, alternatively, effectively instantaneously by mechanical or manual charging, at a temperature of from about 80° C. to about 94° C. and at an air flow rate of from about 5 CFM to about CFM; (f) providing a slurry or syrup of a third reduced-sugar coating composition; (g) applying the slurry or syrup of a third reduced-sugar coating composition to the carrier by spray coating at a rate of from about 2.0 grams to about 60.0 grams slurry or syrup per about 100 grams carrier per minute, at a temperature of from about 80° C. to about 95° C., and at an air flow rate of from about 5 CFM to about 15 CFM, and in such manner that the moisture content of the carrier is kept below 5% by weight; (h) increasing the temperature to from about 95° C. to about 110° C.; (i) holding the applying conditions at from about 95° C. to about 110° C. until the moisture content of the carrier decreases to about 2% by weight; wherein the sugar content of the reduced-sugar coating composition, as applied to the carrier, is in a range of from about 3 grams to about 8 grams per about 29-gram (about 1-ounce) serving, more preferably from about 4 grams to about 7 grams per about 29-gram (about 1-ounce) serving. In one embodiment, the above method for coating a carrier with a reduced-sugar coating composition further comprises providing, and then applying, a composition comprising one or more flavorants, after step (g). In an embodiment, the carrier can comprise a RTE cereal.

In yet another embodiment, the present disclosure provides a method for coating a carrier with a reduced-sugar coating composition, comprising the steps of: (a) heating the carrier to maintain a temperature of from about 75° C. to about 85° C.; (b) providing a slurry or syrup of a first reduced-sugar coating composition comprising; (c) applying the slurry or syrup of a first reduced-sugar coating composition to the carrier by spray coating at a rate of from about 2.0 grams to about 60.0 grams slurry or syrup per about 100 grams carrier per minute, at a temperature of from about 80° C. to about 94° C., and at an air flow rate of from about 5 CFM to about 15 CFM, and in such manner that the moisture content of the carrier is kept below 5% by weight; (d) providing a seed slurry or syrup; (e) applying the seed slurry or syrup to the carrier by spray coating at a rate of from about 1.0 grams to about 5.0 grams seed slurry or syrup per about 100 grams carrier per minute, at a temperature of from about 80° C. to about 94° C., and at an air flow rate of about 5 CFM to about 15 CFM; (f) providing a slurry or syrup of a third reduced-sugar coating composition; (g) applying the slurry or syrup of a third reduced-sugar coating composition to the carrier by spray coating at a rate of from about 0.5 grams to about 4.5 grams slurry or syrup per about 100 grams carrier per minute, at a temperature of from about 80° C. to about 94° C., and at an air flow rate of from about 5 CFM to about 15 CFM, and in such manner that the moisture content of the carrier is kept below 5% by weight; (h) increasing the temperature to from about 95° C. to about 110° C.; (i) holding the applying conditions at from about 95° C. to about 110° C. until the moisture content of the carrier decreases to about 2% by weight; wherein the sugar content of the reduced-sugar coating composition, as applied to the carrier, is in a range of from about 3 grams to about 8 grams per about 29-gram (about 1-ounce) serving, more preferably from about 4 grams to about 7 grams per about 29-gram (about 1-ounce) serving. In one embodiment, the above method for coating a carrier with a reduced-sugar coating composition further comprises providing, and then applying, a composition comprising one or more flavorants, after step (g). In an embodiment, the carrier can comprise a RTE cereal.

### BRIEF DESCRIPTION OF THE DRAWINGS

FIG. 1 depicts a photograph of RTE cereal corn flakes coated with a reduced-sugar coating composition, prepared in accordance with an embodiment of the present invention.

### DETAILED DESCRIPTION

In the current marketplace, it is desirable to significantly decrease the consumption of sugar in ready-to-eat (“RTE”) cereal, and similar dry products, and yet allow the final RTE cereal product to be appreciably similar in appearance and overall experience to the full-sugar version of the RTE cereal product.

In an aspect, a reduced-sugar coating composition, having a frosted appearance, is applied to RTE cereals. Other possible uses of a reduced-sugar coating composition as described herein are for coating any primarily dry foods, including, but not limited to, crackers, breads, cakes, cookies, and the like.

In another aspect, a syrup or slurry (i.e., “reduced-sugar coating composition”) is described herein, intended to provide a substantially reduced amount of sugar to any food product (i.e., “carrier”) to which it is applied, while maintaining a substantial sweetness profile (i.e., similar to that of a “full-sugar” product). Following application of such syrup or slurry reduced-sugar coating composition to a carrier, such syrup or slurry reduced-sugar coating composition can then be heated, via a method for coating a carrier with a reduced-sugar coating composition (i.e., “manufacturing process”) described herein, in such a way as to offer a recrystallized or “frosted” appearance while offering a similar experience to that of the full-sugar product.

Reduced-Sugar Coating Composition

In an aspect, a food product, such as a RTE cereal, may include, but is not limited to, a reduced-sugar coating composition and a carrier to which the reduced-sugar coating composition is applied.

In one embodiment, a reduced-sugar coating composition as described herein may comprise a “syrup” or “slurry,” comprising: sugar (Source: Cane), used at from about 0% to about 50% dry weight; gum arabic (Source: Acacia seyal), used at from about 1% to about 65% dry weight; maltodextrin (Source: Corn or Tapioca), used at from about 5% to about 35% dry weight; calcium carbonate for appearance (Source: Mineral), used at from about 0% to about 25% dry weight an edible oil (Source: Safflower or Coconut), used at from about 0% to about 25% dry weight; and, optionally, cocoa powder blend (Source: Cacao, sugar, and other ingredients), used at from about 0% to about 50% dry weight.

In another embodiment, a reduced-sugar coating composition as described herein may comprise a “syrup” or “slurry,” comprising: gum arabic (i.e., “gum acacia,” or “acacia”) of varietal acacia seyal; corn- or tapioca-based maltodextrin; mineral or precipitated calcium carbonate; coconut or safflower oil; sweetener modifiers such as sodium chloride (i.e., “table salt”); high-intensity sweeteners, including, including but not limited to, one or more high-intensity sweetener selected from the group consisting of Thaumatin, Stevia, and Lo Han Guo (i.e., “monk fruit powder extract,” “luo han guo,” or “luo han”); one or more flavorants dispersed into water; and, optionally, a cocoa powder blend.

In yet another embodiment, a reduced-sugar coating composition as described herein may comprise a “seeding system,” comprising: an edible oil (Source: Safflower or Coconut), used at from about 0% to about 5% dry weight; icing sugar (Source: Cane), used at from about 0% to about 7.5% dry weight; maltodextrin (Source: Corn or Tapioca), used at from about 0% to about 15% dry weight; and calcium carbonate (Source: Mineral), used at from about 0% to about 15% dry weight.

In yet another embodiment, a reduced-sugar coating composition as described herein may comprise a flavorant, comprising an ingredient added in order to enhance, increase, or otherwise benefit the taste and perception of the finished carrier. Such an ingredient may be selected from the group consisting of a high-intensity sweetener, cacao, vanilla, a fruit, a fruit juice, vegetable purees, a plant extract, a natural syrup or powder, and the like. In an embodiment, a high-intensity sweetener is selected from, but not limited to, thaumatin, brazzein, and monellin, and the like. In an embodiment, a plant extract is selected from, but not limited to, monk fruit extract, stevia, stevioside(s), mogroside(s), and the like. In an embodiment, a natural syrup or powder may be selected from the group consisting of agave, yacon, tapioca, chicory, rice, vanilla bean, honey, palmyra jiggery, maple, birch, mixtures thereof, and the like. In an embodiment, such a reduced-sugar coating composition comprises one or more such flavorants, used at from about 0.8% to about 25% dry weight, combined.

The term “flavorant,” as used herein, unless otherwise stated, means an ingredient added in order to enhance, increase, or otherwise benefit the taste and perception of the finished carrier. A flavorant is selected from the group consisting of a high-intensity sweetener, cacao, vanilla, a fruit, a fruit juice, vegetable purees, a plant extract, a natural syrup or powder, a flavor, a malt powder, a natural flavor, an artificial flavor, a combination of a natural flavor and an artificial flavor, any combination thereof, or the like. In an embodiment, a high-intensity sweetener is selected from, but not limited to, thaumatin, brazzein, and monellin, and the like. In an embodiment, a plant extract is selected from, but not limited to, monk fruit extract, stevia, stevioside(s), mogroside(s), and the like. In an embodiment, a natural syrup or powder may be selected from the group consisting of agave, yacon, tapioca, chicory, rice, vanilla bean, honey, palmyra jiggery, maple, birch, mixtures thereof, and the like.

In an embodiment, sugar (Source: Sucrose) may be added to a reduced-sugar coating composition to achieve desired performance of the reduced-sugar coating composition.

In an embodiment, a high-intensity sweetener is an example of a flavorant that can be used to maintain sweetness in a reduced-sugar coating composition of the present invention.

In an embodiment, one or more maltodextrins added to the reduced-sugar coating compositions of the present invention comprise residual amounts of simple sugars. Preferably, the one or more maltodextrins added to the reduced-sugar coating compositions of the present invention comprises from about 2% to about 8% simple sugars by weight. When added to an embodiment of the reduced-sugar coating compositions of the present invention, such simple sugars must be accounted for in determination of the total sugar content of the finished reduced-sugar coating compositions of the present invention.

The term “sugar content,” as used herein, unless stated otherwise, refers to the amount by weight of compounds including, but not limited to, edible disaccharides such as sucrose, edible monosaccharides such as glucose or fructose, and the like. This definition is intended to generally agree with the current USDA standards for “sugars” in a serving of food, e.g., RTE cereal.

In an embodiment, a reduced-sugar coating composition of the present invention is dispersed via low-shear mixing to minimize foaming, when applied as a single solution prepared by adding, for example, into filtered water, in the following order, the following ingredients:

(a) Thaumatin into water;

(b) Lo Han Guo into the mixture of step (a);

(c) Flavorants into the mixture of step (b);

(d) Maltodextrin into the mixture of step (c);

(e) Fructan and/or dextrin into the mixture of step (d);

(f) Calcium carbonate into the mixture of step (e); and

(g) Gum arabic into the mixture of step (f).

In an embodiment, the reduced-sugar coating composition of the present invention prepared according to steps (a)-(g), as a slurry or syrup, can be then applied at a temperature from about 60° C. to about 84° C. via spray application to a substantially dry material (i.e., “carrier”) that can preferably be dried and heated via forced air and preferably dried in a fluidized bed to ensure proper adhesion and an even coating.

The term “carrier,” as used herein, unless stated otherwise, refers to any substantially dry base upon which a reduced-sugar coating composition of the present invention can be adhered. Without limitation, a carrier may comprise oats, wheat, barley, corn, rice, soy, or a mixture thereof. Without limitation, a carrier may be in such form as to be extruded, flaked, puffed, flattened, or otherwise processed into, for example, a RTE cereal blend. Without limitation, a carrier is typically comprised of distinct pieces that would be unevenly coated in a fluidized/drum drying method due to size and progression of such distinct pieces.

Without limitation, in an embodiment, a reduced-sugar coating composition of the present invention may be applied to, for example, nutritional bars, energy bars, extruded snacks, baked goods, or any item similarly dried, baked, or processed to form a sweetening effect and/or “frosted” effect on the reduced-sugar coating composition.

Methods for Coating a Carrier with a Reduced-Sugar Coating Composition

In an embodiment, a reduced-sugar coating composition of the present invention comprising, for example, starches, dietary fiber, calcium carbonate, and gum arabic may be used to slow coating rate, with an accordingly measured application of heat and airflow, to create a particular carbohydrate recrystallization effect that imparts a “frosting” appearance pleasing to a consumer. In another embodiment, some components may be varied in order to incorporate other components, such as, for example, flavorants; however, substantial removal of any one such component in particular results in an inconsistent finished product.

In an embodiment, a method for coating a carrier with a reduced-sugar coating composition comprises a gradual drying process during application of a reduced-sugar coating composition, including, but not limited to, forced heated air in order to maintain a reduced-sugar coating composition on a carrier such that localized moisture content remains less than about 5% by weight. At such a point that the moisture content of a carrier coated with a reduced-sugar coating composition of the present invention is similar to that of the carrier before coating with the reduced-sugar coating composition of the present invention, for example, about 1% to about 2% by weight, a desirable “frosted” appearance is achieved and the method for coating a carrier with a reduced-sugar coating composition of the present invention is considered complete. If a method for coating a carrier with a reduced-sugar coating composition of the present invention is performed for too long a duration of time or at too high of a holding temperature, the carrier will be burned, thereby creating highly undesirable off-flavors or off-notes.

In an embodiment, a method for coating a carrier with a reduced-sugar coating composition comprises applying the reduced-sugar coating composition to the carrier at particular conditions and particular settings. In one embodiment, the moisture content of a reduced-sugar coating composition of the present invention, for example, a moisture content from about 10% to about 40% by weight, and the substantially dry nature of a carrier, for example, a moisture content from about 1% to about 3% by weight, dictate that the reduced-sugar coating composition should be applied to the carrier at a rate of no greater than about 50 grams per about 100 grams carrier per minute, at a temperature no greater than 95° C., and at an air flow rate of from about 5 CFM to about 15 CFM.

In one embodiment of a method for coating a carrier with a reduced-sugar coating composition of the present invention, the rate of application of a reduced-sugar coating composition to a carrier can be increased or decreased in order to fit a variety of application systems, as long as the application of the reduced-sugar coating composition to the carrier employs accordingly an air flow rate such as to decrease the moisture content of the reduced-sugar coating composition on the surface of the carrier to less than about 5% by weight, preferably less than about 3% by weight. Without limitation, for example, if in an embodiment, the rate of application of a reduced-sugar coating composition to a carrier is increased, the application of the reduced-sugar coating composition to the carrier employs accordingly a higher air flow rate such as to decrease the moisture content of the reduced-sugar coating composition on the surface of the carrier to less than about 5% by weight, preferably less than about 3% by weight. Similarly, without limitation, for example, if in an embodiment, the rate of application of a reduced-sugar coating composition to a carrier is decreased, the application of the reduced-sugar composition to the carrier employs accordingly a lower air flow rate such as to decrease the moisture content of the reduced-sugar coating composition on the surface of the carrier to less than about 5% by weight, preferably less than about 3% by weight.

In an embodiment of a method for coating a carrier with a reduced-sugar coating composition of the present invention, after completion of a final applying step of such a method, the temperature of the heat source employed for practicing such a method may be increased to about 110° C. such as to decrease the moisture content of the reduced-sugar coating composition on the surface of the carrier to less than about 2% by weight while holding the air flow rate at from about 5 CFM to about 15 CFM, thereby providing a reduced-sugar coating composition that can rapidly harden and recrystallize to provide a “frosted” appearance.

In another embodiment of a method for coating a carrier with a reduced-sugar coating composition of the present invention, after such a time that the moisture content of the reduced-sugar composition on the surface of the carrier decreases to about 2% by weight, the air flow rate can be increased to about 30 CFM (i.e., greater than or equal to about 100% of an increase from the initial air flow rate value), and the temperature of the heat source employed for practicing such a method may be increased to about 250° C. such that the reduced-sugar coating composition on the surface of the carrier increases to a temperature from about 150° C. to about 175° C. for a duration of time from about 3 seconds to about 5 seconds, thereby providing a reduced-sugar coating composition that can rapidly harden and recrystallize to provide a “frosted” appearance.

In embodiments of methods for coating a carrier with a reduced-sugar coating composition of the present invention, critically the duration of time at which the reduced-sugar coating composition on the surface of the carrier has a temperature higher than about 110° C. must be minimized, due to the nature of the carrier to burn, given the high carbohydrate content of the carrier. Accordingly, to minimize the risk of a carrier from burning, after completion of a final applying step of such a method, the carrier may be moved at an increased rate. Employing a high-heat treatment upon a reduced-sugar coating composition on the surface of a carrier that is already appreciably dry and subject to non-enzymatic browning means that the threshold for creating a consistent product is a matter of seconds at most. Burning the carrier also results in an “over-volatilized” and bitter flavor developing in the reduced-sugar coating composition.

In embodiments of methods for coating a carrier with a reduced-sugar coating composition of the present invention, critically the use of ingredients such as polysaccharides and starches results in viscous solutions, whereby the rate of the spray coating of the applying step(s) is favorably decreased, but whereby the duration of time of the holding step must be increased, adversely affecting the finished appearance of the reduced-sugar coating composition on the surface of the carrier and the ability of the reduced-sugar coating composition on the surface of the carrier to recrystallize if allowed to adsorb into the carrier.

Thus, in embodiments of methods for coating a carrier with a reduced-sugar coating composition of the present invention, the use of particular temperature and rate parameters are limiting due to the inexact nature of the spray coating of the applying step(s).

In embodiments of methods for coating a carrier with a reduced-sugar coating composition of the present invention, adverse effects upon the methods can be mitigated. Without limitation, by defining the dosing rate and droplet size of the spray coating of the applying step(s), the methods for coating a carrier with a reduced-sugar coating composition of the present invention can be tuned and made highly precise. Without limitation, alternatively, or collaterally, by optimizing the air flow rate, temperature, and/or rate of movement of the carrier during the applying step(s), the methods for coating a carrier with a reduced-sugar coating composition of the present invention can be tuned and made highly precise. In one embodiment of a method for coating a carrier with a reduced-sugar coating composition of the present invention, an additional drying step employing infrared radiation and/or use of an extremely high-heat and/or high air-flow-rate tunnel (i.e., similar to a “puffing tower”) would aid in beneficially minimizing exposure of the carrier to heat sources.

Known methods in the art utilize a sugary syrup (e.g., sucrose-based syrup) as the primary ingredient. Because such syrups naturally recrystallize at high concentrations, the application of heat is unnecessary in such known methods. In contrast to such known methods, in a principal embodiment, a method for coating a carrier with a reduced-sugar coating composition of the present invention may comprise particular temperatures for the applying step(s) and/or holding step, thereby allowing a substantially different resultant reduced-sugar coating composition on the surface of the carrier to be formed, with a minimum amount of sugar present, compared to coatings resulting from known methods in the art. Given that, in this embodiment, the method for coating a carrier with a reduced-sugar coating composition utilizes a fluidized bed coating and drying method, an even coating may be achieved regardless of viscosity of the reduced-sugar coating composition as long as the temperature of the reduced-sugar coating composition is maintained at from about 60° C. to about 95° C. during the applying step(s), thereby providing a substantially lowered viscosity of the reduced-sugar coating composition and adequately rapid drying of the reduced-sugar coating composition.

In one embodiment, to achieve desired performance of the methods disclosed herein for coating a carrier with a reduced-sugar coating composition, more than one reduced-sugar coating composition may be applied in series. In another embodiment, to achieve desired performance of the methods disclosed herein for coating a carrier with a reduced-sugar coating composition, more than one reduced-sugar coating composition may be applied in parallel. In yet another embodiment, to achieve desired performance of the methods disclosed herein for coating a carrier with a reduced-sugar coating composition, more than one reduced-sugar coating composition may be applied sequentially.

In a preferred embodiment, a method for coating a carrier with a reduced-sugar coating composition of the present invention offers added benefit when heated during the holding step, as heating creates a substantial seal around the carrier, thereby increasing the resistance of the carrier to absorbing moisture.

In a principal aspect, the methods for coating a carrier with a reduced-sugar coating composition of the present invention constitute a substantial improvement over known methods. For example, known sugar-reduction formulae and methods may reduce sugar content from 12 grams of sugar per 28-gram serving to 9 grams of sugar per 28-gram serving by addition of a Type-4 resistant starch. See WO2012068203 A1 to Vande Geissen et al., incorporated by reference herein in its entirety. By contrast, the methods for coating a carrier with a reduced-sugar coating composition of the present invention provide a novel, surprising, and unexpected reduction to about 3 grams of sugar (and up to about 8 grams of sugar), more preferably a reduction to about 4 grams of sugar (and up to about 7 grams of sugar), for a RTE cereal that customarily contains about 11 grams of sugar per 29-gram serving. Therefore, it is demonstrated herein that a from about 27 to about 73% by weight, preferably a from about 36 to about 63% by weight, reduction in sugar can be achieved.

In an embodiment, a method for coating a carrier with a reduced-sugar coating composition of the present invention comprises the steps of:

(a) heating the carrier to maintain a temperature of from about 60° C. to about 84° C.;

(b) providing a slurry or syrup of a reduced-sugar coating composition;

(c) applying the slurry or syrup of the reduced-sugar coating composition to the carrier by spray coating at a rate of from about 0.5 grams to about 6.0 grams slurry or syrup per about 100 grams carrier per minute, at a temperature of from about 80° C. to about 94° C., and at an air flow rate of from about 5 CFM to about 15 CFM, and in such manner that the moisture content of the carrier is kept below 5% by weight;

(d) increasing the temperature to from about 95° C. to about 110° C.;

(e) holding the applying conditions at from about 95° C. to about 110° C. until the moisture content of the carrier decreases to about 2% by weight;

wherein the sugar content of the reduced-sugar coating composition, as applied to the carrier, is in a range of from about 3 grams to about 8 grams per about 29-gram (about 1-ounce) serving, more preferably from about 4 grams to about 7 grams per about 29-gram (about 1-ounce) serving.

In one embodiment, the above method for coating a carrier with a reduced-sugar coating composition further comprises providing and applying a powder seed crystal composition comprising maltodextrin and sugar after step (c).

In another embodiment, the above method for coating a carrier with a reduced-sugar coating composition further comprises providing and applying a powder seed crystal composition comprising maltodextrin, sugar, and an edible oil after step (c).

In yet another embodiment, the above method for coating a carrier with a reduced-sugar coating composition further comprises providing, and then applying, a composition comprising one or more flavorants, after step (c).

In yet another embodiment, the carrier can comprise a RTE cereal.

In an embodiment, a method for coating a carrier with a reduced-sugar coating composition of the present invention comprises the steps of:

(a) heating the carrier to maintain a temperature of from about 60° C. to about 85° C.;

(b) providing a slurry or syrup of a reduced-sugar coating composition;

(c) applying the slurry or syrup of a reduced-sugar coating composition to the carrier by spray coating at a rate of from about 2.0 grams to about 60.0 grams slurry or syrup per about 100 grams carrier per minute, at a temperature of from about 80° C. to about 94° C., and at an air flow rate of from about 5 CFM to about 15 CFM, and in such manner that the moisture content of the carrier is kept below 5% by weight;

(d) providing a powder seed crystal composition;

(e) applying the powder seed crystal composition to the carrier by sifting or, alternatively, effectively instantaneously by mechanical or manual charging, at a temperature of from about 80° C. to about 94° C. and at an air flow rate of from about 5 CFM to about CFM;

(f) providing a slurry or syrup of a second reduced-sugar coating composition;

(g) applying the slurry or syrup of a second reduced-sugar coating composition to the carrier by spray coating at a rate of from about 2.0 grams to about 60.0 grams slurry or syrup per about 100 grams carrier per minute, at a temperature of from about 80° C. to about 94° C., and at an air flow rate of from about 5 CFM to about 15 CFM, and in such manner that the moisture content of the carrier is kept below 5% by weight;

(h) increasing the temperature to from about 95° C. to about 110° C.;

(i) holding the applying conditions at from about 95° C. to about 110° C. until the moisture content of the carrier decreases to about 2% by weight;

wherein the sugar content of the reduced-sugar coating composition, as applied to the carrier, is in a range of from about 3 grams to about 8 grams per about 29-gram (about 1-ounce) serving, more preferably from about 4 grams to about 7 grams per about 29-gram (about 1-ounce) serving.

In one embodiment, the above method for coating a carrier with a reduced-sugar coating composition further comprises providing, and then applying, a composition comprising one or more flavorants, after step (g).

In another embodiment, the carrier can comprise a RTE cereal.

In an embodiment, a method for coating a carrier with a reduced-sugar coating composition of the present invention comprises the steps of:

(a) heating the carrier to maintain a temperature of from about 75° C. to about 85° C.;

(b) providing an a slurry or syrup of a reduced-sugar coating composition;

(c) applying the slurry or syrup of a reduced-sugar coating composition to the carrier by spray coating at a rate of from about 2.0 grams to about 60.0 grams slurry or syrup per about 100 grams carrier per minute, at a temperature of from about 80° C. to about 94° C., and at an air flow rate of from about 5 CFM to about 15 CFM, and in such manner that the moisture content of the carrier is kept below 5% by weight;

(d) providing a seed slurry or syrup;

(e) applying the seed slurry or syrup to the carrier by spray coating at a rate of from about 1.0 grams to about 5.0 grams seed slurry or syrup per about 100 grams carrier per minute, at a temperature of from about 80° C. to about 94° C., and at an air flow rate of about 5 CFM to about 15 CFM;

(f) providing a slurry or syrup of a second reduced-sugar coating composition;

(g) applying the slurry or syrup of a second reduced-sugar coating composition to the carrier by spray coating at a rate of from about 0.5 grams per about 4.5 grams slurry or syrup to about 100 grams carrier per minute, at a temperature of from about 80° C. to about 94° C., and at an air flow rate of from about 5 CFM to about 15 CFM, and in such manner that the moisture content of the carrier is kept below 5% by weight;

(h) increasing the temperature to from about 95° C. to about 110° C.;

(i) holding the applying conditions at from about 95° C. to about 110° C. until the moisture content of the carrier decreases to about 2% by weight;

wherein the sugar content of the reduced-sugar coating composition, as applied to the carrier, is in a range of from about 3 grams to about 8 grams per about 29-gram (about 1-ounce) serving, more preferably from about 4 grams to about 7 grams per about 29-gram (about 1-ounce) serving.

In one embodiment, the above method for coating a carrier with a reduced-sugar coating composition further comprises providing, and then applying, a composition comprising one or more flavorants, after step (g).

In another embodiment, the carrier can comprise a RTE cereal.

The reduced-sugar coating compositions and methods for coating a carrier with a reduced-sugar coating composition described herein may be further understood in connection with the following non-limiting Examples.

### EXAMPLE 1

The following is a preparation of a reduced-sugar coating composition that may be provided and applied for the methods of the present invention, which comprise providing and applying the reduced-sugar coating composition to the carrier in at least a single step.

A slurry of a reduced-sugar coating composition of the present invention, in a wet formulation, comprises the ingredients in dry weight percentages as listed in Table 1. The Solution 1 of Table 1 may be applied to a carrier as a first reduced-sugar coating composition.

TABLE 1
SOLUTION 1

| Ingredient | Weight % |
|---|---|
| Water | 65.941% |
| Stevia | 0.158% |
| Lo Han Guo Extract | 0.264% |
| Maltodextrin* | 8.792% |
| Gum Arabic | 19.343% |
| Fructooligosaccharide | 5.275% |
| Vanilla Extract | 0.220% |
| Thaumatin | 0.007% |

*Maltodextrin 18DE (Ingredion Inc., Westchester, Illinois)

The ingredients, in the specific amounts according to dry weight percentage, were combined by low-shear mixing as described above.

Brix of Solution 1: 33.8 at 22.4° C. Brix of major constituents, at appropriate weight percentages, which are represented in Solution 1 at 22.4° C.: gum arabic, 18.5; maltodextrin 18DE, 10.2; fructooligosaccharide, 4.6. Total Brix: 33.3 degrees Brix. Degrees Brix was measured using Hann Instruments H196801 Refractometer (Woonsocket, R.I., United States).

The term “degrees Brix,” abbreviated “° Bx,” as used herein, unless otherwise stated, refers to the sugar content of an aqueous solution. For example, one degree Brix corresponds to 1 gram of sucrose in 100 grams of solution, and represents the strength of the solution as percentage by mass. If the solution contains dissolved solids other than pure sucrose, then the degrees Brix only approximates the dissolved solid content.

pH of overall Solution 1: 4.46. pH was measured using calibrated Hanna edge^{pH} meter (Woonsocket, R.I., United States).

Viscosity was defined by Brookfield (Middleboro, Mass., United States) DV3T Model RV fitted with UL Adapter and UL spindle. Speed: 45.0 RPM. Viscosity: 85.90 cP±1.42 cP. Shear Stress: 47.27 dyne/sec. Shear Rate: 55.04 1/sec.

Without being bound by theory, each of the ingredients of the reduced-sugar coating composition of Example 1 serves a particular purpose or function, as follows:

Without being bound by theory, each of the Stevia, Lo Han Guo Extract, Vanilla Extract, and Thaumatin serves as a sweetness enhancer by its traditionally defined characteristics as a high-intensity sweetener and/or by its ability to aromatize and lead towards that profile.

Without being bound by theory, the maltodextrin not only increases in viscosity in order to allow localized application of the slurry of the reduced-sugar coating composition of the present invention, but also serves as a basis for general crystallization via the effect of super-saturation. Without limitation, useful maltodextrin grades include, but are not limited to, 10DE, 15DE, 18DE, and the like.

Without being bound by theory, the gum arabic offers several distinct functional benefits. First, the gum arabic adheres to many surfaces, specifically with a dramatic affinity for water, and creates a surface to which many layers can adhere until dry, with minimal impact on viscosity at lower concentrations. Second, though gum arabic has a minimal effect on viscosity, gum arabic is a good emulsifier and can foam when required. Third, gum arabic has a tendency to help equalize solutions that have been mixed with high-intensity sweeteners. Fourth, gum arabic can create a solid, coated layer that extends bowl life, repels water, and increases the “crunch” of the product to which it is applied.

Without being bound by theory, the dietary fiber (i.e., “fructooligosaccharide”) not only offers nutritional benefits, which are frequently few and far between in highly sweetened products, but also allows for an increase in the dissolved solids, which helps slow the application rate similarly to maltodextrin.

### EXAMPLE 2

The methods for coating a carrier with a reduced-sugar coating composition of the present invention may comprise applying the first reduced-sugar coating composition to the carrier in a single step.

The slurry of the reduced-sugar coating composition, in a wet formulation, comprising the ingredients in dry weight percentages as listed in Example 1, Table 1: Solution 1, was applied to RTE cereal corn flakes (gram-scale or kilogram-scale) as follows:

In order to practice a method for coating a carrier with a reduced-sugar coating composition of the present invention, comprising applying the reduced-sugar coating composition to the carrier in a single step, particular properties of the reduced-sugar coating composition and particular conditions of the applying step of the method are employed. The high moisture content of the slurry of the reduced-sugar coating composition, from about 60% to about 70% by weight, and the low moisture content (i.e., “dry”) nature of the carrier, from about 1% to about 3% by weight, dictates that the slurry of the reduced-sugar coating composition be applied at a rate no greater than about 45 grams of the slurry of the reduced-sugar coating composition per about 100 grams carrier per minute, at from about 60° C. to about 80° C., and at an air flow rate of from about 5 CFM to about 15 CFM.

In some embodiments, the rate of application of the reduced-sugar coating composition to the carrier of the applying step(s) of a method can be increased in order to effectively cooperate with various systems, as long as the air flow rate of the applying step(s) of the method for coating a carrier with a reduced-sugar coating composition is increased so as to maintain the moisture content of the reduced-sugar coating composition on the surface of the carrier to less than about 5%, preferably less than about 3%.

The conditions for the applying step of the method for coating a carrier with a reduced-sugar coating composition of Example 2 are that after such time that the moisture content of the reduced-sugar coating composition on the surface of the carrier decreases to about 2%, increasing the air flow rate to about 30 CFM (about 100% increase from the initial value), and increasing the temperature of the heat source to about 250° C. in order to allow the carrier coated with the reduced-sugar coating composition to reach a temperature from about 150° C. to about 175° C. for from about 3 seconds to about 5 seconds. Such conditions will immediately allow the reduced-sugar coating composition on the surface of the carrier to harden and recrystallize, giving a “frosted” appearance, and producing a dry product as in Table 2.

The reduced-sugar coating composition on the surface of the carrier comprises the ingredients in dry weight percentages as listed in Table 2.

TABLE 2

| Ingredient | Weight % |
|---|---|
| Stevia | 0.465% |
| Lo Han Guo Extract | 0.774% |
| Maltodextrin* | 26.015% |
| Gum Arabic | 56.992% |
| Fructooligosaccharide | 15.689% |
| Vanilla | 0.045% |
| Thaumatin | 0.020% |

*Maltodextrin 18DE (Ingredion Inc., Westchester, Illinois)

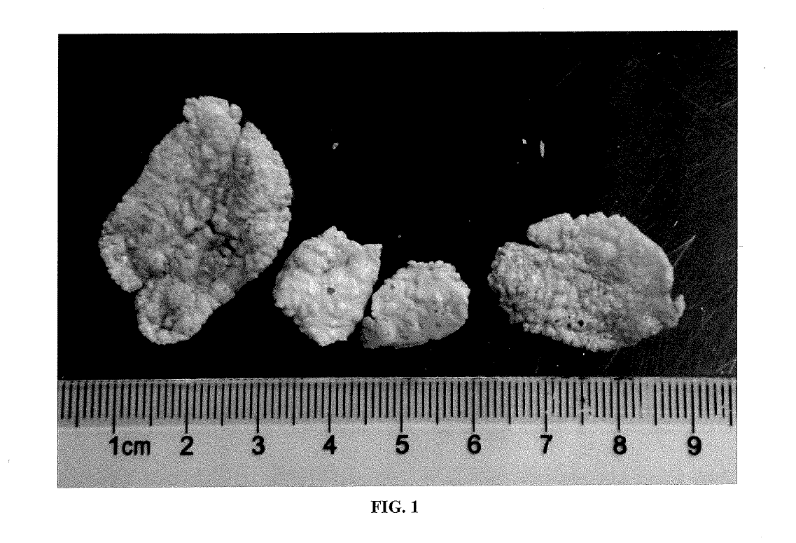

The dry weight percentages provided in Table 2 would, for example, represent the reduced-sugar coating composition on the surface of the carrier, the carrier itself comprising 3 grams of sugar per 29-gram serving independently of the reduced-sugar coating composition, whereby the total sugar content of the reduced-sugar coating composition on the surface of the carrier decreased from about 7 grams of sugar per 29-gram serving to about 3 grams of sugar per 29-gram serving, as defined by commonly utilized industry practices for calculations of nutritional information. The applying step(s) of the present Example 2 represents effective elimination of the total sugar content from a coating on a carrier, by industry and analytical standards. Stated another way, effective elimination of the total sugar content, by industry and analytical standards has been observed. At the very least, the from about 56% to about 58% reduction in total sugar content is substantial in the present Example 2. Standard testing for total sugar content is provided at USDA's National Nutrient Database for Standard Reference, Release 27: Product Basic Report 08020, Cereals ready-to-eat, KELLOGG, KELLOGG'S Corn Flakes (http://ndb.nal.usda.gov/ndb/foods/show/1830?fgcd=&manu=&1facet=&format=&count=&max=35&offset=&sort=&qlookup=corn+flakes, report date Jul. 16, 2015), listing total sugars as 2.66 grams per 28-gram serving. The method of the present Example 2 uses a similar calculation, using Genesis Nutrition Software (Salem, Oreg., United States), the database of which is the same National Nutrient Database. The reduced-sugar coating composition on the surface of the carrier, where the carrier is RTE cereal corn flakes, prepared in present Example 2, having a “frosted” appearance, a reduced-sugar coating composition with moisture content of less than about 5%, preferably less than about 3%, and a total sugar content of about 3 grams per 29-gram serving is shown in FIG. 1.

Other suitable test methods include, but are not limited to: AOAC Method 945.66—Total Reducing Sugars, via the Lane-Eynon/Munson-Walker General Method; and AOAC Method 896.02—Sucrose in Sugars and Syrups via Polarimeter and Wet Chemistry.

Separate tests that were conducted have varied the amounts of each of the respective ingredients listed in Table 2 from effectively eliminating each ingredient (i.e., a negligible amount) to up to about 25% increase in each ingredient by dry weight.

Without being bound by theory, in the case of the high-intensity sweeteners and flavors listed in Table 2, the resultant reduced-sugar coating composition on the surface of the carrier had a taste that was either particularly bitter, or so dramatically sweet, that the resultant reduced-sugar coating composition on the surface of the carrier was entirely inedible.

Without being bound by theory, the increased percentage of solids required an associated increase in the amount of reduced-sugar coating composition per piece of carrier, which at least offered a visual difference. However, increasing the weight percent of maltodextrin resulted only in an increase in viscosity of the reduced-sugar coating composition, whereas the elimination or decrease of the weight percent of maltodextrin resulted in a very fluid reduced-sugar coating composition that was difficult to dose and that was too high in moisture content to be applied to a carrier.

Without being bound by theory, increasing the amount of dietary fiber resulted in minimal differences in appearance. However, due to dietary concerns, the amount of dietary fiber can be manipulated as needed, up to about 25% dry weight.

Without being bound by theory, the amount of gum arabic in the reduced-sugar coating composition prepared with ingredients according to Table 2 appears to be a critical variable. Increasing the amount of gum arabic in the reduced-sugar coating composition prepared with ingredients according to Table 2 from about 45% to about 65% dry weight yielded a measurable difference in the amount of whitening or “frosting” observed. However, a reduced-sugar coating composition with ingredients according to Table 2 comprising higher amounts of gum arabic by dry weight percentage results in decreased solubility of the ingredients therein and in the high likelihood of such a reduced-sugar coating composition to foam, thereby causing inconsistent reduced-sugar coating compositions on the surface of carriers where the reduced-sugar coating composition comprised more than about 65% dry weight gum arabic. Likewise, a reduced-sugar coating composition with ingredients according to Table 2 comprising lower amounts of gum arabic by dry weight percentage results in incomplete coating of the carrier and minimizes the capacity of the carrier coated with the reduced-sugar coating composition to resist moisture absorption.

Without being bound by theory, increasing the rate of application of the reduced-sugar coating composition to the carrier of the applying step(s) of a method well beyond the prescribed value, for example, to about 100 grams of reduced-sugar coating composition per 100 grams carrier per minute, yielded a soggy and deteriorated carrier, on which the reduced-sugar coating composition would not crystallize, and had an inferior and glass-like structure, lacking the desired “frosted” appearance. Decreasing the rate of application of the reduced-sugar coating composition to the carrier of the applying step(s) of a method was effective, but caused no benefit to the product and seemed to create off-notes even at lower temperatures.

Without being bound by theory, decreasing the temperature during the applying step(s) of a method for coating a carrier with a reduced-sugar coating composition with ingredients according to Table 2, prior to the high heat of the holding step, while seemingly positive, resulted only in an inferiorly textured and flavored reduced-sugar coating composition on the surface of the carrier, due to the duration of time that the reduced-sugar coating composition spends in the applying and holding steps of the method. Increasing the temperature during the applying step(s) of a method for coating a carrier with a reduced-sugar coating composition with ingredients according to Table 2, for example, above about 80° C., yielded similar results to the results observed when the duration of time that the reduced-sugar coating composition on the surface of the carrier is exposed to the conditions of the holding step is too long, i.e., producing bitter flavor and burnt appearance of the underlying carrier.

### EXAMPLE 3

The methods for coating a carrier with a reduced-sugar coating composition of the present invention may comprise applying more than one reduced-sugar coating composition to the carrier, individually, in more than one applying step.

The slurry of the reduced-sugar coating composition, in a wet formulation, comprises the ingredients in dry weight percentages as listed in Table 3. The Film-Forming Slurry of Table 3 may be applied to a carrier as a first reduced-sugar coating composition.

TABLE 3
FILM-FORMING SLURRY

| Ingredient | Weight % |
|---|---|
| Water | 21.539% |
| Sugar | 50.257% |
| Calcium carbonate | 15.385% |
| Maltodextrin* | 12.821% |

*Maltodextrin 18DE (Ingredion Inc., Westchester, Illinois)

The ingredients listed in Table 3, in the specific amounts according to dry weight percentage, were combined by low-shear mixing as described above.

Brix of film-forming slurry in Table 3: 75.7 at 21.9° C. Degrees Brix was measured using Hanna Instruments H196801 Refractometer (Woonsocket, R.I., United States).

pH of overall film-forming slurry in Table 3: 7.85. pH was measured using a calibrated Hanna edge^{pH} meter (Woonsocket, R.I., United States).

Viscosity was defined by Brookfield (Middleboro, Mass., United States) DV3T Model RV fitted with RV/HA/HB spindle #5. Speed: 50.0 RPM. Viscosity: 5208 cP. Torque: 65.1. Temperature: 20.9° C.

Separate tests that were conducted have varied the amounts of each of the respective ingredients listed in Table 3 from effectively eliminating each ingredient (i.e., a negligible amount) to up to about 50% increase in each ingredient by dry weight.

Without being bound by theory, the increased percentage of solids required an associated increase in the amount of reduced-sugar coating composition per piece of carrier, which at least offered a visual difference. However, increasing the dry weight percent of maltodextrin resulted only in an increase in viscosity of the reduced-sugar coating composition, whereas the elimination, or decrease, of the weight percent of maltodextrin resulted in a very fluid reduced-sugar coating composition that was difficult to dose and that was too high in moisture content to be applied to a carrier. Additionally, increasing the dry weight percentage of calcium carbonate resulted in an agglomerated solution, and the elimination of calcium carbonate reduced the whitened appearance for some formulations. Notably the ratio of maltodextrin to calcium carbonate may be used to define ideal whitening or “frosting” for different coating applications. Overall, amounts of dry solids above about 25% dry weight resulted in a chalky and unpleasant mouthfeel.

Without being bound by theory, the amount of sugar in the slurry of the reduced-sugar coating composition with ingredients according to Table 3 can be adjusted, along with the other ingredients, such as to provide adequate sweetness in conjunction with sugar-reduction benefits.

Without being bound by theory, increasing the rate of application of the reduced-sugar coating composition to the carrier of the applying step(s) of a method well beyond the prescribed value, for example, to about 100 grams of reduced-sugar coating composition per about 100 grams carrier per minute, yielded a soggy and deteriorated carrier, on which the reduced-sugar coating composition would not crystallize, and which had an inferior and glass-like structure, lacking the desired “frosted” appearance. In some embodiments, the prescribed value of the rate of application of the reduced-sugar coating composition to the carrier of the applying step(s) of a method yielded excessive clumping and a non-uniform coating distribution on the carrier. Decreasing the rate of application of the reduced-sugar coating composition to the carrier of the applying step(s) of a method was effective, but caused no benefit to the product and seemed to create off-notes even at lower temperatures.

The methods for coating a carrier with a reduced-sugar coating composition of the present invention may comprise applying at least one seed slurry system to the carrier individually in at least one applying step.

A seed slurry system, in a representative formulation, comprises the ingredients in dry weight percentages as listed in Table 4. The Seed Slurry System of Table 4 may be applied to a carrier as a second sugar-based coating composition.

TABLE 4
SEED SLURRY SYSTEM

| Ingredient | Weight % |
|---|---|
| Safflower Oil | 55.556% |
| Sugar* | 44.444% |

*Confectioner's Sugar (Domino, Yonkers, New York)

The ingredients listed in Table 4, in the specific amounts according to dry weight percentage, were combined by low-shear mixing as described above.

Brix of seed slurry system in Table 4: 71.6 at 21.0° C. Degrees Brix was measured using Hanna Instruments H196801 Refractometer (Woonsocket, R.I., United States).

pH of overall seed slurry system in Table 4: 7.23. pH was measured using a calibrated Hanna edge^{pH} meter (Woonsocket, R.I., United States).

Viscosity was defined by Brookfield (Middleboro, Mass., United States) DV3T Model RV fitted with RV/HA/HB spindle #5. Speed: 80.0 RPM. Viscosity: 3110 cP. Torque: 62.2. Temperature: 22.1° C.

Separate tests that were conducted have varied the amounts of each of the respective ingredients listed in Table 4 from effectively eliminating each ingredient (i.e., a negligible amount) to up to about 100% increase in each ingredient of the dry weight of the seed slurry system.

Without being bound by theory, the increased percentage of solids in the seed slurry system of the reduced-sugar coating composition with ingredients according to Table 4 resulted in an increased rate of drying and recrystallization upon application of other slurries or syrups of the reduced-sugar coating composition. Additionally, removal of solids from the seed slurry system of the reduced-sugar coating composition with ingredients according to Table 4 resulted in a decreased rate of drying, in edible oil absorption into the carrier matrix, and in preparation of a soggy carrier.

Separate tests that were conducted have varied the amount of seed slurry system used in the methods for coating a carrier with a reduced-sugar coating composition of the present invention from about 0% to about 30% by dry weight of the reduced-sugar coating composition.

Separate tests that were conducted have also independently included maltodextrin and calcium carbonate as part of the seed slurry system at up to about 30% by dry weight of the seed slurry system. It is expected that any dry solid that could absorb water and enable recrystallization of subsequent coating additions would perform in a similar manner.

Without being bound by theory, increasing the rate of application of the seed slurry system of the reduced-sugar coating composition to the carrier of the applying step of a method well beyond the prescribed value, for example, to about 100 grams of the seed slurry system of the reduced-sugar coating composition per about 100 grams carrier per minute yielded a brittle, aggolomerated, surface finish that may cause a chalky texture perception. In some embodiments, the prescribed value caused agglomerated and fused carrier pieces, resulting in a significant amount of multiples of carrier pieces.

The methods for coating a carrier with a reduced-sugar coating composition of the present invention may comprise applying at least one sweetening slurry system to the carrier individually in at least one applying step.

A sweetening slurry system, in a representative formulation, comprises the ingredients in dry weight percentages as listed in Table 5. The Sweetening Slurry System of Table 5 may be applied to a carrier as a third reduced-sugar coating composition.

TABLE 5
SWEETENING SLURRY SYSTEM

| Ingredient | Weight % |
|---|---|
| Water, filtered | 78.627% |
| Gum Arabic | 17.260% |
| Sweetener Blend | 4.114% |

The ingredients listed in Table 5, in the specific amounts according to dry weight percentage, were combined by low-shear mixing as described above.

Separate tests that were conducted have varied the amounts of each of the respective ingredients listed in Table 5 from effectively eliminating each ingredient (i.e., a negligible amount) to up to about 100% increase in each ingredient of the dry weight of the sweetening slurry system.

Without being bound by theory, the increased percentage of solids in the sweetening slurry system of the reduced-sugar coating composition with ingredients according to Table 5 resulted in a noticeably enhanced sweetness.

The overall dry weight of the natural high intensity sweeteners in the sweetening slurry system used in the reduced-sugar coating composition should not substantiate more than from about 2% to about 3% of the total dry weight of the reduced-sugar coating composition on the surface of the carrier, to ensure that sweetness is not oversaturated.

The overall dry weight of the sweetening slurry system could substantiate up to about 65% by weight of the reduced-sugar coating composition as provided and applied to the carrier, as a way of enhancing visual appearance of the reduced-sugar coating composition through an application of high heat.

Separate tests that were conducted have varied the amount of sweetening slurry system used in the methods for coating a carrier with a reduced-sugar coating composition of the present invention from about 0% to about 25% by dry weight of the reduced-sugar coating composition.

The methods for coating a carrier with a reduced-sugar coating composition of the present invention may comprise applying an example sweetening slurry blend to the carrier individually in at least one applying step.

Example sweetening slurry blends, in representative formulations, comprise the ingredients in dry weight percentages as listed in Tables 6 and 7.

TABLE 6
EXAMPLE SWEETENING SLURRY BLENDS

| | A | B | C | D | E | F | G | H |
|---|---|---|---|---|---|---|---|---|
| Ingredients | (Wt %) | (Wt %) | (Wt %) | (Wt %) | (Wt %) | (Wt %) | (Wt %) | (Wt %) |
| 1% Thaumatin | 26.4% | 31.5% | 39.2% | 35.0% | 26.0% | 18.8% | 20.4% | 18.5% |
| Powder in | | | | | | | | |
| Maltodextrin | | | | | | | | |
| Stevia Powder | 4.2% | 5.1% | 6.3% | 3.8% | 5.6% | 4.0% | 3.3% | 3.0% |
| Monkfruit Extract | 4.2% | 5.1% | 6.3% | 3.8% | 4.2% | 3.0% | 3.3% | 3.0% |
| Vanilla Extract | 65.1% | 58.3% | 48.3% | 57.5% | 64.2% | 46.3% | 50.3% | 45.7% |
| Powder | | | | | | | | |
| Salt | 0.0% | 0.0% | 0.0% | 0.0% | 0.0% | 5.6% | 4.6% | 5.0% |
| Natural Sweet | 0.0% | 0.0% | 0.0% | 0.0% | 0.0% | 22.3% | 18.2% | 24.8% |
| Flavor | | | | | | | | |
| Total | 100% | 100% | 100% | 100% | 100% | 100% | 100% | 100% |

TABLE 7
FURTHER EXAMPLE SWEETENING SLURRY BLENDS

| | I | J | | |
|---|---|---|---|---|
| | (Weight | (Weight | K | L |
| Ingredients | %) | %) | (Weight %) | (Weight %) |
| 1% Thaumatin Powder in | 7.5% | 14.8 | 12.0% | 8.8% |
| Maltodextrin | | | | |
| Stevia | 1.2% | 2.4% | 2.6% | 2.6% |
| Monkfruit Extract | 1.2% | 2.4% | 1.9% | 1.4% |
| Vanilla Extract Powder | 18.5% | 27.4% | 29.7% | 21.7% |
| Salt | 0.0% | 0.0% | 3.6% | 2.6% |
| Natural Sweet Flavor | 0.0% | 0.0% | 14.3% | 10.5% |
| Yacon Syrup | 71.6% | 53.0% | 0.0% | 0.0% |
| Erythritol | 0.0% | 0.0% | 35.8% | 52.4% |
| Total | 100.0% | 100.0% | 100.0% | 100.0% |

Example sweetening slurry blends, according to the ingredients listed in Tables 6 and 7, were first taste-tested after the example sweetening slurry blends were incorporated into solutions made of about 10% sugar by weight, about 90% filtered water by weight, and from about 0% to about 1% by weight one of the example sweetening slurry blends listed in Tables 6 and 7, in order to rapidly ascertain their sweetening ability and magnitude before being applied as a component of a reduced-sugar coating composition. An example sweetening slurry blend was considered a “good quality” sweetening slurry blend if it did not produce a bitter taste either during or after consumption of a reduced-sugar coating composition on the surface of a carrier. The term “magnitude,” as used herein, unless stated otherwise, refers to the level of perceived sweetness of a carrier.

The ingredients listed in Tables 5 and 6 were combined by low-shear mixing as described above to prepare the sweetening slurry blends according to the ingredients listed in Table 5 comprising the example sweetening slurry blends according to the ingredients listed in Table 6.

Brix of sweetening slurry system using sweetening slurry blend according to the ingredients listed for Sweetener F in Table 6: 19.8 at 22.8° C. Degrees Brix was measured using Hanna Instruments H196801 Refractometer (Woonsocket, R.I., United States).

pH of sweetening slurry system using sweetening slurry blend according to the ingredients listed for Sweetener F in Table 6: 4.3. pH was measured using a calibrated Hanna edge^{pH} meter (Woonsocket, R.I., United States).

Viscosity, for sweetening slurry system using sweetening slurry blend according to the ingredients listed for Sweetener F in Table 6, was defined by Brookfield (Middleboro, Mass., United States) DV3T Model RV fitted with RV/HA/HB spindle #2. Speed: 58.6 RPM. Viscosity: 234 cP. Torque: 58.6. Temperature: 21.8° C.

The methods for coating carrier with a reduced-sugar coating composition of the present invention may comprise applying at least one reduced-sugar coating composition to the carrier individually in at least one applying step.

A reduced-sugar coating composition as applied to a carrier in an applying step of a method of the present invention comprises the ingredients in dry weight percentages as listed in Table 8.

TABLE 8
REDUCED-SUGAR COATING COMPOSITION

| Ingredient | Weight % |
|---|---|
| Sugar | 54.532% |
| Calcium carbonate | 14.463% |
| Maltodextrin* | 12.053 |
| Safflower Oil | 9.106% |
| Flavor Oil | 6.749% |
| Gum Arabic | 2.495% |
| Vanillin Powder | 0.279% |
| Natural Sweet Flavor | 0.134% |
| 1% Thaumatin Powder in | 0.113% |
| Maltodextrin | |
| Salt | 0.034% |
| Stevia | 0.024% |
| Monk Fruit Extract | 0.018% |

*Maltodextrin 18DE (Ingredion inc., Westchester, Illinois)

The dry weight percentages provided in Table 8 would, for example, represent the reduced-súgar coating composition on the surface of the carrier, the carrier itself comprising 3 grams of sugar per 29-gram serving independently of the reduced-sugar coating composition, whereby the total sugar content of the reduced-sugar coating composition on the surface of the carrier decreased from about 10 grams of sugar per 29-gram serving to about 5 grams of sugar per 29-gram serving, as defined by commonly utilized industry practices for calculations of nutritional information. The applying step(s) of the present Example 3 represents substantial reduction of the total sugar content, specifically from about 36% to about 63% reduction, from a coating on a carrier, by industry and analytical standards. Stated another way, substantial reduction of the total sugar content, by industry and analytical standards, has been observed. At the very least, the from about 36% to about 63% reduction in total sugar content is substantial in the present Example 3. Standard testing for sugar content is provided at USDA's National Nutrient Database for Standard Reference, Release 27: Product Basic Report 08020, Cereals ready-to-eat, KELLOGG, KELLOGG'S Corn Flakes (http://ndb.nal.usda.gov/ndb/foods/show/1830?fgcd=&manu=&1facet=&format=&count=&max=35&offset=&sort=&qlookup=corn+flakes, report date Jul. 16, 2015), listing total sugars as 2.66 grams per 28-gram serving. The method of the present Example 3 uses a similar calculation, using Genesis Nutrition Software (Salem, Oreg., United States), the database of which is the same National Nutrient Database. The reduced-sugar coating composition on the surface of the carrier, where the carrier is RTE cereal corn flakes, prepared in present Example 3, according to the ingredients listed for Sweetener F in Table 6, and as incorporated into the reduced-sugar coating composition on the surface of the carrier as listed in Table 8, has a measured total sugar content of 5 grams per 29-gram serving and is shown in FIG. 1.

### EXAMPLE 4

The methods for coating a carrier with a reduced-sugar coating composition of the present invention may comprise applying more than one reduced-sugar coating composition to the carrier, individually, in more than one applying step.

The film-forming slurry of the reduced-sugar coating composition, in a representative wet formulation, comprises the ingredients in dry weight percentages as listed in Table 9. The Film-Forming Slurry of Table 9 may be applied to a carrier as a first reduced-sugar coating composition.

TABLE 9
FILM-FORMING SLURRY

| Ingredient | Weight % |
|---|---|
| Water | 35.770% |
| Sugar | 30.267% |
| Maltodextrin* | 13.758% |
| Cocoa Blend, Dry | 13.070% |
| Coconut Oil, Refined | 4.678% |
| Sweetener Blend | 2.459% |

*Maltodextrin 18DE (Ingredion Inc., Westchester, Illinois)

The ingredients listed in Tables 6 and 9 were combined by low-shear mixing as described above to prepare the film-forming slurry according to the ingredients listed in Table 9 comprising the example sweetening slurry blends according to the ingredients listed in Table 6.

Brix of film forming slurry (using Table 6, example sweetener slurry blend F) prepared according to Table 8: 60 at 23.4° C. Degrees Brix was measured using Hanna Instruments H196801 Refractometer (Woonsocket, R.I., United States).

pH of overall film-forming slurry (using Table 6, example sweetening slurry blend F) prepared according to Table 9: 6.9. pH was measured using a calibrated Hanna edge^{pH} meter (Woonsocket, R.I., United States).

Viscosity was defined by Brookfield (Middleboro, Mass., United States) DV35 Model RV fitted with RV/HA/HB spindle #4. Speed: 130 RPM. Viscosity: 871 cP. Torque: 56.6. Temperature: 21.3° C.

Separate tests that were conducted have varied the amounts of each of the respective ingredients listed in Table 9 from effectively eliminating each ingredient (i.e., a negligible amount) to up to about 25% increase in each ingredient of the dry weight of the film-forming slurry.

Without being bound by theory, in the case of the high-intensity and sweeteners, effective elimination and about 25% increase of such ingredients respectively resulted in a particularly bitter reduced-sugar coating composition on the surface of a carrier or a reduced-sugar coating composition on the surface of a carrier that was so dramatically sweetened that it was entirely inedible.

Without being bound by theory, the increased percentage of solids required an associated increase in the amount of reduced-sugar coating composition per piece of carrier, which at least offered a visual difference. However, increasing the dry weight percent of maltodextrin resulted only in an increase in viscosity of the reduced-sugar coating composition, whereas the elimination, or decrease, of the weight percent of maltodextrin resulted in a very fluid reduced-sugar coating composition that was difficult to dose and that was too high in moisture content to be applied to a carrier.

Without being bound by theory, increasing the dry weight percent of cocoa powder blend resulted in an agglomerated film-forming slurry that was not easy to handle or apply via spray coating to the surface of a carrier. Most commonly, problems with increasing the cocoa powder blend were associated with the blocking of the nozzle spray as a function of high slurry viscosity and with effects on drying.

Without being bound by theory, increasing the rate of application of the reduced-sugar coating composition to the carrier of the applying step(s) of a method well beyond the prescribed value, for example, to about 100 grams of reduced-sugar coating composition per about 100 grams carrier per minute, yielded a soggy and deteriorated carrier, on which the reduced-sugar coating composition would not crystallize, and had an inferior and glass-like structure. Decreasing the rate of application of the reduced-sugar coating composition to the carrier of the applying step(s) of a method was effective, but caused no benefit to the product and seemed to create off-notes even at lower temperatures.

Without being bound by theory, decreasing the temperature during the applying step(s) of a method for coating a carrier with a reduced-sugar coating composition with ingredients according to Table 9, prior to the high heat of the holding step, while seemingly positive, resulted only in an inferiorly textured and flavored reduced-sugar coating composition on the surface of the carrier, due to the duration of time that the reduced-sugar coating composition spends in the applying and holding steps of the method. Increasing the temperature during the applying step(s) of a method for coating a carrier with a reduced-sugar coating composition with ingredients according to Table 9, for example, above about 80° C., yielded similar results to the results observed when the duration of time that the reduced-sugar coating composition on the surface of the carrier is exposed to the conditions of the holding step is too long, i.e., producing better flavor and burnt appearance of the underlying carrier.

A dry-charge seed powder system comprising as much as about 100% by dry weight maltodextrin was included in this reduced-sugar coating composition and was sequentially applied between applying steps for the reduced-sugar coating composition prepared according to the ingredients listed in Table 9. Without being bound by theory, increasing the overall dry weight percentage of maltodextrin dry-charge resulted in a chalky and unappealing visual appearance, lower uniformity of coating of the surface of the carrier with the reduced-sugar coating composition, and white granule agglomerates of reduced-sugar coating composition on the surface of the carrier.

The methods for coating a carrier with a reduced-sugar coating composition of the present invention may comprise applying at least one appearance slurry system to the carrier individually in at least one applying step.

An appearance slurry system, in a representative formulation, comprises the ingredients in dry weight percentages as listed in Table 10. The Appearance Slurry System of Table 10 may be applied to a carrier as a second reduced-sugar coating composition.

TABLE 10
APPEARANCE SLURRY SYSTEM

| Ingredient | Weight % |
|---|---|
| Water, filtered | 76.684% |
| Gum Arabic | 16.839% |
| Cocoa Powder Blend, Dry | 6.477% |

The ingredients listed in Table 10, in the specific amounts according to dry weight percentage, were combined by low-shear mixing as described above.

Brix of appearance slurry system in Table 10: 29.8 at 23.0° C. Degrees Brix was measured using Hanna Instruments H196801 Refractometer (Woonsocket, R.I., United States).

pH of overall appearance slurry system in Table 10: 5.5. pH was measured using a calibrated Hanna edge^{pH} meter (Woonsocket, R.I., United States).

Viscosity was defined by Brookfield (Middleboro, Mass., United States) DV3T Model RV fitted with RV/IIA/HB spindle #4. Speed: 160 RPM. Viscosity: 748 cP. Torque: 59.8. Temperature: 22.1° C.

Separate tests that were conducted have varied the amounts of each of the respective ingredients listed in Table 10 from effectively eliminating each ingredient (i.e., a negligible amount) to up to about 25% increase in each ingredient of the dry weight of the appearance slurry system.

Without being bound by theory, increasing the dry weight percentage of gum arabic in the appearance slurry system resulted in a greater film viscosity, better film coverage, and improved visual appearance in that the resultant appearance slurry system on the surface of the carrier is almost shiny and/or reflective.

Without being bound by theory, increasing the amount of a cocoa powder blend resulted in an agglomerated appearance slurry system that was not easy to handle or apply via spray coating to the surface of a carrier, and even a disproportionate balance of flavor resulting i a bitter taste.

The methods for coating a carrier with a reduced-sugar coating composition of the present invention may comprise applying more than one reduced-sugar coating composition to the carrier, individually, in more than one applying step.

A reduced-sugar coating composition as applied to a carrier, in a representative formulation, comprises the ingredients in dry weight percentages as listed in Table 11.

TABLE 11
REDUCED-SUGAR COATING COMPOSITION

| Ingredient | Weight % |
|---|---|
| Sugar | 39.507% |
| Cocoa Powder Blend | 21.549% |
| Maltodextrin* | 17.957% |
| Gum Arabic | 11.672% |
| Coconut Oil, Refined | 6.106% |
| Vanilla Extract Powder | 1.486% |
| Natural Sweet Flavor | 0.716% |
| 1% Thaumatin Powder in | 0.603% |
| Maltodextrin | |
| Salt | 0.180% |
| Stevia | 0.128% |
| Monk Fruit Extract | 0.096% |

*Maltodextrin 18DE (Ingredion Inc., Westchester, Illinois)

The dry weight percentages provided in Table 11 would, for example, represent the reduced-sugar coating composition on the surface of the carrier, the carrier itself comprising about 3 grams of sugar per 29-gram serving independently of the reduced-sugar coating composition, whereby the total sugar content of the reduced-sugar coating composition on the surface of the carrier decreased from about 12 grams of sugar per 29-gram serving to about 6 grams of sugar per 29-gram serving, as defined by commonly utilized industry practices for calculations of nutritional information. The applying step(s) of the present Example 4 represents substantial reduction of the total sugar content, specifically from about 36% to about 63% reduction, from a coating on a carrier, by industry and analytical standards. Stated another way, substantial reduction of the total sugar content, by industry and analytical standards, has been observed. At the very least, the from about 36% to about 63% reduction in total sugar content is substantial in the present Example 4. Standard testing for sugar content is provided at USDA's National Nutrient Database for Standard Reference, Release 27: Product Basic Report 08020, Cereals ready-to-eat, KELLOGG, KELLOGG'S Corn Flakes (http://ndb.nal.usda.gov/ndb/foods/show/1830?fgcd=&manu=&1facet=&format=&count=&max=35&offset=&sort=&qlookup=corn+flakes, report date Jul. 16, 2015), listing total sugars as 2.66 grams per 28-gram serving. The method of the present Example 4 uses a similar calculation, using Genesis Nutrition Software (Salem, Oreg., United States), the database of which is the same National Nutrient Database. The reduced-sugar coating composition on the surface of the carrier, where the carrier is RTE cereal corn flakes, prepared in present Example 4, according to the ingredients listed for Sweetener F in Table 6, and as incorporated into the reduced-sugar coating composition on the surface of the carrier as listed in Table 11, has a measured total sugar content of 6 grams per 29-gram serving and is shown in FIG. 1.

Without being bound by theory, each of the ingredients of the reduced-sugar coating composition as applied to a carrier of the present Example 4 serves a particular purpose or function, as follows:

Without being bound by theory, each of the Stevia, Vanilla Extract Powder, Monkfruit Extract and Thaumatin Powder serves as a sweetness enhancer by its traditionally defined characteristics as a high-intensity sweetener and/or by its ability to aromatize and lead towards that profile.

Without being bound by theory, the maltodextrin not only increases in viscosity in order to allow localized application of the slurry of the reduced-sugar coating composition of the present invention, but also serves as a basis for general crystallization via the effect of super-saturation. Preferably, applying maltodextrin as a powder provides a reduction of viscosity of the reduced-sugar coating composition, thereby facilitating the applying step(s) of a method for coating a carrier with such a reduced-sugar coating composition, while maintaining a high level of total overall solids added to the reduced-sugar coating composition in order to decrease the dry weight percentage of sugar added. Without limitation, useful maltodextrin grades include, but are not limited to, 10DE, 15DE, 18DE, and the like.

Without being bound by theory, the gum arabic offers several distinct functional benefits. First, the gum arabic adheres to many surfaces, specifically with a dramatic affinity for water, and creates a surface to which many layers can adhere until dry, with minimal impact on viscosity at lower concentrations. Second, though gum arabic has a minimal impact on viscosity, gum arabic is a good emulsifier and can foam when required. Third, gum arabic has a tendency to help equalize solutions that have been mixed with high-intensity sweeteners. Fourth, gum arabic can create a solid, coated layer that extends bowl life, repels water, and increases the “crunch” of the product to which it is applied.

Without being bound by theory, a cocoa powder blend provides chocolate flavor and a deeper color, in order to match expectations of a chocolate-flavored product. Cocoa powder blend also contributes sweetness to the overall flavor.

Delivery System

The embodiments of the present invention described herein are edible and fit for human use. Use for animal feed is also contemplated.

Embodiments of a carrier of the present invention include, but are not limited to, puffs, puffed snacks, crunchy snacks, bite-sized snacks, bars (with or without added protein and/or fibers), ready-to-eat (“RTE”) cereals (with or without added protein and/or fiber), toppings, powder products, baby food, relief foods, instantized foods, and the like.

Various forms or shapes can be accommodated in the embodiments of a carrier of the present invention. Forms and/or shapes may be selected from the group consisting of a cereal piece, chip, flake, cluster, puff, sphere, ribbon, biscuit, chex-like shape, and O-shape. Such shapes can be formed during a manufacturing process, such as, for example, extrusion followed by automated knife-cutting. By using an extrusion process, the cereal or cereal piece(s) embodiments of a carrier can be formed into a variety of consumer-preferred shapes including, but not limited to: flakes, ribbons, “chex” or “chex-like,” biscuits, or O-shapes (e.g., “O's”). Other useful baked or puffed shapes include, but are not limited to: puffs, spheres, clusters, and the like.

A food serving of a reduced-sugar coating composition on the surface of a carrier as described herein can be in the form of a multiplicity of baked cereal pieces, crisps, or puffs. The serving form can be a packaged preparation, the package containing discrete pieces, such as packaged cereal pieces, crisps, or puffs, or it can be the appropriate number of any of these in packaged form. One useful serving can be dry volume measures as used in baking, such as, for example, ½ or 1 cup.

The edible components (i.e., “active agent”) of the embodiments of a carrier of the present invention may be combined with one or more solid inactive ingredients for the preparation of cereal pieces, crisps, puffs, snacks, tablets, capsules, pills, powders, granules, or other suitable edible dosage forms. For example, an active agent may be combined with at least one excipient such as fillers, binders, emulsifiers, humectants, disintegrating agents, solution retarders, absorption accelerators, wetting agents, absorbents, or lubricating agents. Other useful excipients include, but are not limited to, magnesium stearate, calcium stearate, calcium sulfate, mannitol, xylitol, sweeteners, starch, carboxymethylcellulose, microcrystalline cellulose, silica, gelatin, silicon dioxide, and the like. Other useful excipients include, but are not limited to: carrier materials, such as starch, gelatin, acacia, microcrystalline cellulose, kaolin, dicalcium phosphate, calcium carbonate, sodium chloride, alginic acid, and the like; disintegrators, such as microcrystalline cellulose, alginic acid, and the like; binders, such as acacia, methylcellulose, sodium carboxymethylcellulose, polyvinylpyrrolidone, hydroxypropyl methylcellulose, ethyl cellulose, and the like; and lubricants or flow agents, such as magnesium stearate, calcium stearate, stearic acid, silicone fluid, talc, edible waxes, edible oils, colloidal silica, and the like. The usefulness of such excipients is well known in the art.

The finished product of embodiments of a carrier of the present invention may be shaped as appropriate for a RTE cereal, for example, or another appropriate shape for an edible snack food. Other shapes include, but are not limited to, rings, squares, scoops, chips, crisps, and the like. Individual pieces can be combined or formed into embodiments of a carrier of the present invention including, but not limited to, bars or other edible structures or configurations.

Extruded and/or baked products of embodiments of a carrier of the present invention may be coated by methods for coating a carrier with a reduced-sugar coating composition of the present invention. For example, post-extrusion coating can include, but is not limited to, methods for coating a carrier with a reduced-sugar coating composition comprising applying a reduced-sugar coating composition comprising flavors, spices, colors, and/or other nutrient mixes. Nutrient mixes can include, but are not limited to, vitamins and minerals.

The methods for coating a carrier with a reduced-sugar coating composition as described herein can also be utilized on a variety of other food products that exhibit dry, non-porous exteriors that would benefit from a sugar-reduction/removal process, including, but not limited to, baked goods, extruded snacks, puffed snacks, cakes, cookies, and the like.

It has been established that there are a variety of methods for coating a carrier with a reduced-sugar coating composition as described herein, or at least, that there are acceptable tolerances in every one of the components associated with the embodiments as described herein including, but not limited to, increasing or decreasing dry weight percentages of ingredients, adding or removing specific method steps, adjusting conditions or properties, and the like.

The use of the terms “a,” “an,” “the,” and similar referents in the context of describing the presently claimed invention (especially in the context of the claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. In some embodiments, use of the term “about” is intended to describe values either above or below the stated value in a range of approximately ±10% ; in other embodiments, the values may range in value either above or below the stated value in a range of approximately ±5%; in other embodiments, the values may range in value either above or below the stated value in a range of approximately ±2%; in other embodiments, the values may range in value either above or below the stated value in a range of approximately ±1%. The preceding ranges are intended to be made clear by context, and no further limitation is implied. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

All references cited herein are incorporated by reference in their entirety. The present invention may be embodied in other specific forms without departing from the spirit or essential attributes thereof and, accordingly, reference should be made to the appended claims, rather than to the foregoing specification, as indicating the scope of the invention.

1. A method for coating a carrier with at least one reduced-sugar coating composition, comprising the steps of:
(a) heating the carrier to a temperature of from about 60° C. to about 85° C.;
(b) providing a slurry or syrup of a first reduced-sugar coating composition;
(c) applying the slurry or syrup of the first reduced-sugar coating composition to the carrier by spray coating at a rate of from about 0.5 grams to about 60.0 grams aqueous slurry or syrup per about 100 grams carrier per minute, at a temperature of from about 80° C. to 94° C., and at an air flow rate of from about 5 cubic feet per minute to about 15 cubic feet per minute;
(d) increasing the temperature to from 95° C. to about 110° C.; and
(e) holding the temperature at from 95° C. to about 110° C. until the moisture content of the carrier decreases to about 3% by weight;
wherein the total combined sugar content of the at least one reduced-sugar coating composition is about 3 grams or less per 29-gram serving.

2. The method of claim 1, further comprising the steps of:
(c1) providing a slurry or syrup of a second reduced-sugar coating composition;
(c2) applying the slurry or syrup of the second reduced-sugar coating composition to the carrier by spray coating at a rate of from about 0.5 grams to about 60.0 grams slurry or syrup per about 100 grams carrier per minute, at a temperature of from about 80° C. to 94° C., and at an air flow rate of from about 5 cubic feet per minute to about 15 cubic feet per minute;
wherein steps (c1) and (c2) are performed sequentially, following step (c).

3. The method of claim 2, further comprising the steps of:
(c3) providing a slurry or syrup of a third reduced-sugar coating composition;
(c4) applying the slurry or syrup of the third reduced-sugar coating composition to the carrier by spray coating at a rate of from about 0.5 grams to about 60.0 grams slurry or syrup per about 100 grams carrier per minute, at a temperature of from about 80° C. to 94° C., and at an air flow rate of from about 5 cubic feet per minute to about 15 cubic feet per minute;
wherein steps (c3) and (c4) are performed sequentially, following step (c2).

4. The method of claim 1, wherein the first reduced-sugar coating composition comprises gum arabic, maltodextrin, fructooligosaccharide, one or more high intensity sweeteners, and water.

5. The method of claim 4, wherein the first reduced-sugar coating composition comprises gum arabic from about 0.1 to about 30.0 weight percent, maltodextrin from about 0.1 to about 30.0 weight percent, fructooligosaccharide from about 0.1 to about 10.0 weight percent, and one or more high intensity sweeteners from about 0.1 to about 10.0 total weight percent.

6. The method of claim 5, wherein the first reduced-sugar coating composition comprises gum arabic from about 10.0 to about 20.0 weight percent.

7. The method of claim 5, wherein the first reduced-sugar coating composition comprises maltodextrin from about 5.0 to about 15.0 weight percent.

8. The method of claim 5, wherein the first reduced-sugar coating composition comprises fructooligosaccharide from about 3.0 to about 8.0 weight percent.

9. The method of claim 5, wherein the first reduced-sugar coating composition comprises one or more high intensity sweeteners from about 0.1 to about 2.0 total weight percent.

10. The method of claim 4, wherein the first reduced-sugar coating composition further comprises cacao.

11. The method of claim 10, wherein the first reduced-sugar coating composition comprises cacao from about 5.0 to about 10.0 weight percent.

12. The method of claim 1, wherein the first reduced-sugar coating composition comprises sucrose, calcium carbonate, maltodextrin, and water.

13. The method of claim 12, wherein the first reduced-sugar coating composition comprises sucrose from about 40.0 to about 60.0 weight percent, and the degrees Brix is from about 70.0 to about 80.0 at about 22.0° C.

14. The method of claim 12, wherein the first reduced-sugar coating composition comprises sucrose from about 20.0 to about 40.0 weight percent, and the degrees Brix is from about 55.0 to about 65.0 at about 22.0° C.

15. The method of claim 12, wherein the first reduced-sugar coating composition comprises calcium carbonate from about 0.1 to about 30.0 weight percent.

16. The method of claim 12, wherein the first reduced-sugar coating composition comprises maltodextrin from about 0.1 to about 30.0 weight percent.

17. The method of claim 15, wherein the first reduced-sugar coating composition comprises calcium carbonate from about 10.0 to about 20.0 weight percent.

18. The method of claim 16, wherein the first reduced-sugar coating composition comprises maltodextrin from about 10.0 to about 20.0 weight percent.

19. The method of claim 12, wherein the first reduced-sugar coating composition further comprises cacao from about 10.0 to about 20.0 weight percent.

20. The method of claim 12, wherein the first reduced-sugar coating composition further comprises an edible oil from about 2.0 to about 10.0 weight percent.

21. The method of claim 12, wherein the first reduced-sugar coating composition further comprises a sweetener blend, from about 1.0 to about 5.0 weight percent.

22. The method of claim 21, wherein the sweetener blend comprises thaumatin and maltodextrin in a combined amount from about 15.0 to about 40.0 weight percent.

23. The method of claim 22, wherein the thaumatin comprises about 0.15 to about 0.40 weight percent of the combined amount of thaumatin and maltodextrin.

24. The method of claim 21, wherein the sweetener blend comprises stevia in an amount from about 0.1 to about 10.0 weight percent.

25. The method of claim 21, wherein the sweetener blend comprises monkfruit extract in an amount from about 0.1 to about 10.0 weight percent.

26. The method of claim 21, wherein the sweetener blend comprises vanilla in an amount from about 45.0 to about 70.0 weight percent.

27. The method of claim 21, wherein the sweetener blend comprises sodium chloride in an amount from about 0.1 to about 8.0 weight percent.

28. The method of claim 21, wherein the sweetener blend comprises one or more natural flavors, in a total amount of from about 15.0 to about 25.0 weight percent.

29. The method of claim 2, wherein the second reduced-sugar coating composition comprises an edible oil and sucrose.

30. The method of claim 29, wherein the edible oil is selected from safflower or coconut oil in an amount from about 45.0 to about 65.0 weight percent.

31. The method of claim 30, wherein the edible oil is selected from safflower or coconut oil in an amount from about 50.0 to about 60.0 weight percent.

32. The method of claim 29, wherein the second reduced-sugar coating composition comprises sucrose in an amount from about 40.0 to about 50.0 weight percent and the degrees Brix is from about 65.0 to about 75.0 at about 21° C.

33. The method of claim 2, wherein the second reduced-sugar coating composition comprises gum arabic, cacao, and water.

34. The method of claim 33, wherein the second reduced-sugar coating composition comprises gum arabic in an amount from about 15.0 to about 25.0 weight percent.

35. The method of claim 33, wherein the second reduced-sugar coating composition comprises cacao in an amount from about 0.1 to about 10.0 weight percent.

36. The method of claim 3, wherein the third reduced-sugar coating composition comprises gum arabic, a sweetener blend, and water.

37. The method of claim 36, wherein the third reduced-sugar coating composition comprises gum arabic in an amount from about 15.0 to about 25.0 weight percent.

38. The method of claim 36, wherein the third reduced-sugar coating composition comprises a sweetener blend in a total amount from about 1.0 to about 5.0 weight percent.

39. The method of claim 38, wherein the sweetener blend comprises thaumatin and maltodextrin in a combined amount from about 15.0 to about 40.0 weight percent.

40. The method of claim 39, wherein the thaumatin comprises about 0.15 to about 0.40 weight percent of the combined amount of thaumatin and maltodextrin.

41. The method of claim 38, wherein the sweetener blend comprises stevia in an amount from about 0.1 to about 10.0 weight percent.

42. The method of claim 38, wherein the sweetener blend comprises monkfruit extract in an amount from about 0.1 to about 10.0 weight percent.

43. The method of claim 38, wherein the sweetener blend comprises vanilla in an amount from about 45.0 to about 70.0 weight percent.

44. The method of claim 38, wherein the sweetener blend comprises sodium chloride in an amount from about 0.1 to about 8.0 weight percent.

45. The method of claim 38, wherein the sweetener blend comprises one or more natural flavors, in a total amount of from about 15.0 to about 25.0 weight percent.

46. The method of claim 1, wherein the coating method is performed in batches of carrier or continuously.

47. The method of claim 1, wherein the total combined sugar content of the at least one reduced-sugar coating composition is about 3 grams or less per 29-gram serving.
